(19) United States
(12) Patent Application Publication
(10) Pub. No.: US 2018/0181268 A1
(43) Pub. Date: Jun. 28, 2018

(54) SYSTEMS AND METHODS FOR PROVIDING CONTENT

(71) Applicant: Facebook, Inc., Menlo Park, CA (US)

(72) Inventors: Chen Huang, Sunnyvale, CA (US); Rachel Barrie Tucker, San Francisco, CA (US); Zhuowei Bao, Redwood City, CA (US); Yi Tang, Palo Alto, CA (US); Yingliu Chen, Mountain View, CA (US)

(21) Appl. No.: 15/848,490

(22) Filed: Dec. 20, 2017

Related U.S. Application Data
(60) Provisional application No. 62/438,324, filed on Dec. 22, 2016.

(51) Int. Cl. G06F 3/0482; G06F 3/01; G06F 3/0484

(52) U.S. Cl. CPC G06F 3/0482; G06F 3/017; G06F 2203/04808; G06F 2203/04803; G06F 3/04847

(57) ABSTRACT

Systems, methods, and non-transitory computer-readable media can provide a first interface for presenting a content feed that includes at least one content item, the content item being associated with a link that references external content. A determination is made that the content item was accessed. Data corresponding to the external content is obtained. Data corresponding to the content item is obtained. A second interface that includes a first region and a second region is provided, wherein the content item is displayed in the first region, and wherein the external content is displayed in the second region.

### CROSS-REFERENCE TO RELATED APPLICATIONS

This application claims priority to U.S. Provisional Patent Application No. 62/438,324, filed on Dec. 22, 2016 and entitled “SYSTEMS AND METHODS FOR PROVIDING CONTENT”, which is incorporated in its entirety herein by reference.

### FIELD OF THE INVENTION

The present technology relates to the field of content presentation. More particularly, the present technology relates to techniques for providing content items through computing devices.

### BACKGROUND

Today, people often utilize computing devices (or systems) for a wide variety of purposes. Users can operate their computing devices to, for example, interact with one another, create content, share content, and access information. Under conventional approaches, content items (e.g., images, videos, audio files, etc.) can be made available through a content provider. Users can operate their computing devices to access the content items through the platform. Typically, the content items can be provided, or uploaded, by various entities including, for example, content publishers and also users of the content provider. In some instances, the content items can be categorized and/or curated.

### SUMMARY

Various embodiments of the present disclosure can include systems, methods, and non-transitory computer readable media configured to provide a first interface for presenting a content feed that includes at least one content item, the content item being associated with a link that references external content. A determination is made that the content item was accessed. Data corresponding to the external content is obtained. Data corresponding to the content item is obtained. A second interface that includes a first region and a second region is provided, wherein the content item is displayed in the first region, and wherein the external content is displayed in the second region.

In an embodiment, the data corresponding to the external content is obtained from a first computing system and the data corresponding to the content item is obtained from a second computing system.

In an embodiment, the first computing system is a third-party computing system, and wherein the second computing system is a social networking system.

In an embodiment, the second interface includes an option for collapsing the first region, and wherein, upon selecting the option, the second region in which the external content is being displayed expands to fill the second interface.

In an embodiment, the second interface includes an option for collapsing the second region, and wherein, upon selecting the option, the first region in which the content item is being displayed expands to fill the second interface.

In an embodiment, the systems, methods, and non-transitory computer readable media are configured to detect a gesture for adjusting the second interface and adjust a size of the first region and a size of the second region in response to the gesture.

In an embodiment, the content item corresponds to a video, and wherein playback of the video is presented in the first region.

In an embodiment, the external content corresponds to web content, and wherein the web content is rendered and presented in the second region.

In an embodiment, the systems, methods, and non-transitory computer readable media are configured to determine that an option to close the second interface was selected and provide the first interface for presenting the content feed, wherein the first interface replaces the second interface.

In an embodiment, the first region includes one or more options for engaging with the content item, the options including at least one of: a like option, a comment option, a share option, and one or more reaction options.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example content presentation module, according to an embodiment of the present disclosure.

FIG. 2 illustrates an example of an interface module, according to an embodiment of the present disclosure.

FIGS. 3A-B illustrate example interfaces through which content items are presented with external content, according to an embodiment of the present disclosure.

FIG. 4A-C illustrate example interfaces through which content items are presented with external content, according to an embodiment of the present disclosure.

FIG. 5 illustrates an example method for presenting content items with external content, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Providing Content

People use computing devices (or systems) for a wide variety of purposes. As mentioned, under conventional approaches, a user can utilize a computing device to share content items (e.g., documents, images, videos, audio, etc.) with other users. Under conventional approaches, content items (e.g., images, videos, audio files, etc.) can be made available through a content provider. Users can operate their computing devices to access the content items through the platform. Typically, the content items can be provided, or uploaded, by various entities including, for example, content publishers and also users of the content provider.

Under conventional approaches, a user operating a computing device can access a content provider through a software application running on the computing device. In one example, the software application may be a social networking application which, when executed, can allow the user to log-in and access a social networking system through a display screen of the computing device. In some instances, the user interacting with the social networking application may want to access information that is accessible from a third-party computing system not affiliated with the social networking system. For example, the user may want to access a website that is hosted by a third-party computing system and is unaffiliated with the social networking system. In such instances, a separate software application, e.g., a web browser, may be needed. Thus, in this example, the user operating the computing device may need to switch from the social networking application to a browser application through which a Uniform Resource Locator (URL) can be accessed. The browser application can obtain, or download, content from a computing system that services the URL. Once the content is obtained, the browser application can render and display the content through the display screen of the computing device. In some instances, the social networking application may have a built-in browser for accessing third-party content. However, such built-in browsers can still require the user to switch from an interface in the social networking application through which a content item is being accessed (or viewed) to a different interface through which third-party content can be accessed. Having to switch between applications or interfaces can become disruptive and may affect user engagement with the social networking system. Accordingly, such conventional approaches may not be effective in addressing these and other problems arising in computer technology.

An improved approach overcomes the foregoing and other disadvantages associated with conventional approaches specifically arising in the realm of computer technology. In various embodiments, a user operating a computing device can interact with a social networking system using a software application (e.g., a social networking application) running on the computing device. Using the software application, the user can access various content items (e.g., images, videos, audio files, etc.) that are available through the social networking system. The content items can be presented through a display screen of the computing device as part of a content feed (e.g., news feed), for example. In various embodiments, a content item can be associated with information that references third-party content. For example, a video may be associated, or linked, with a URL that references a website that is hosted by a third-party computing system. In this example, the user operating the computing device can select the video, for example, by performing a tap gesture to access the third-party content. In response, the software application can provide an interface in which both the content item and the third-party content are presented. For example, the interface can include a first region (e.g., top portion of the display screen) in which the video is played and a second region (e.g., bottom portion of the display screen) in which the third-party (e.g., website) is rendered and presented. While interacting with the second region, the user is able to browse the third-party content as if the third-party content were being accessed through a traditional browser.

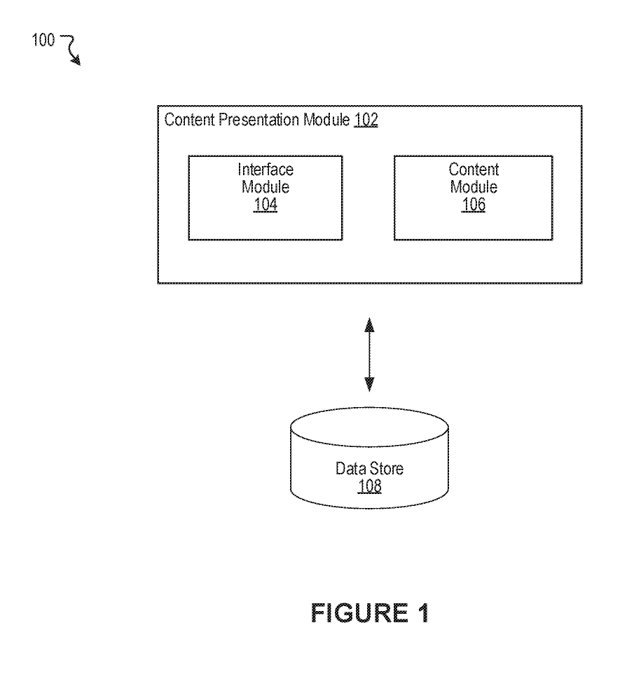

FIG. 1 illustrates an example system 100 including an example content presentation module 102, according to an embodiment of the present disclosure. As shown in the example of FIG. 1, the content presentation module 102 can include an interface module 104 and a content module 106. In some instances, the example system 100 can include at least one data store 108. The components (e.g., modules, elements, etc.) shown in this figure and all figures herein are exemplary only, and other implementations may include additional, fewer, integrated, or different components. Some components may not be shown so as not to obscure relevant details.

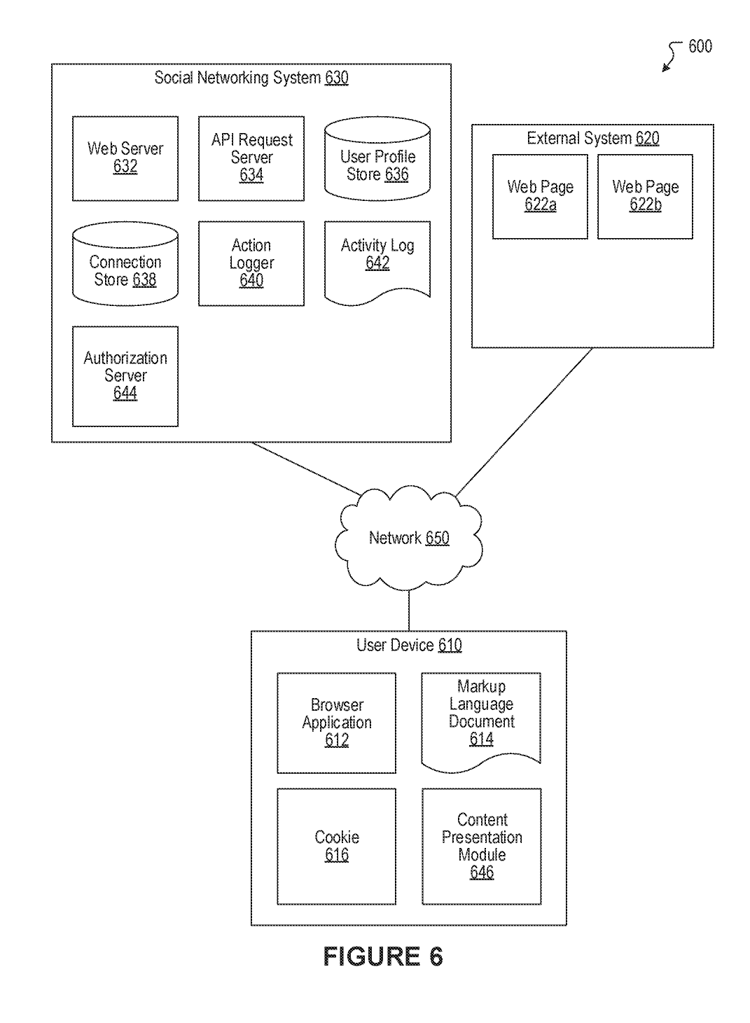

In some embodiments, the content presentation module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the content presentation module 102 can be implemented, in part or in whole, as software running on one or more computing devices or systems, such as on a user computing device or client computing system. For example, the content presentation module 102, or at least a portion thereof, can be implemented as or within an application (e.g., app), a program, or an applet, etc., running on a user computing device or a client computing system, such as the user device 610 of FIG. 6. Further, the content presentation module 102, or at least a portion thereof, can be implemented using one or more computing devices or systems that include one or more servers, such as network servers or cloud servers. In some instances, the content presentation module 102 can, in part or in whole, be implemented within or configured to operate in conjunction with a social networking system (or service), such as the social networking system 630 of FIG. 6. It should be understood that there can be many variations or other possibilities.

In some embodiments, the content presentation module 102 can be configured to communicate and/or operate with the at least one data store 108 in the example system 100. The at least one data store 108 can be configured to store and maintain various types of data. In various embodiments, the at least one data store 108 can store data relevant to the function and operation of the content presentation module 102. One example of such data includes content items that are available to be presented by the interface module 104. In some implementations, the at least one data store 108 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 108 can store information associated with users, such as user identifiers, user information, profile information, user specified settings, content produced or posted by users, and various other types of user data. It should be appreciated that there can be many variations or other possibilities.

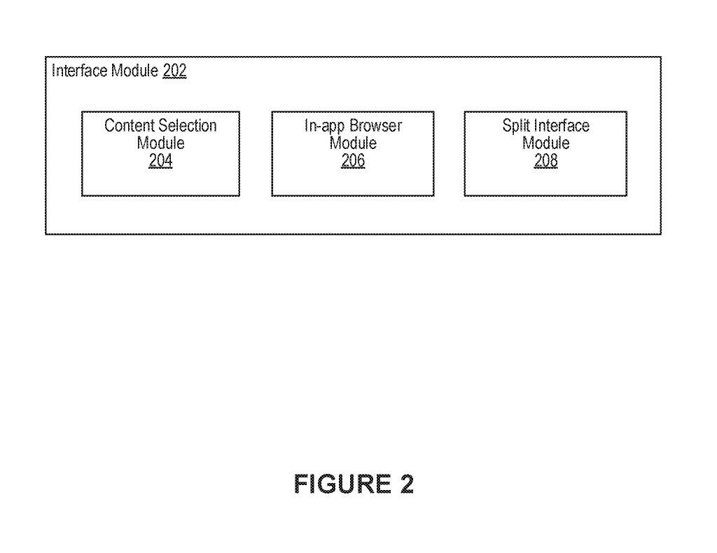

In various embodiments, the content presentation module 102 can utilize the interface module 104 and the content module 106 to provide content items to users. The interface module 104 can be configured to provide an interface (e.g., graphical user interface) through which content items can be presented and accessed. For example, the interface can be provided through a software application (e.g., a social networking application, browser, etc.) running on a computing device (e.g., the user device 610 of FIG. 6) being operated by a user. The user can interact with the interface, for example, by performing touch screen gestures through a display screen of the computing device. In some embodiments, one region of the interface is used to present content items while another region of the interface is used to present third-party content. More details regarding the interface module 104 will be provided below in reference to FIG. 2.

The content module 106 can be configured to provide various types of content items that can be presented to users through the interface provided by the interface module 104. For example, the content module 106 can interact with a content provider system, such as the social networking system 630 of FIG. 6, to obtain various content items to be presented through the interface module 104. The content items can be presented through a display screen of the computing device, for example, as part of a content feed (e.g., news feed). Users can navigate (e.g., browse) the content feed through a display screen of the computing device to access the different content items that are available in the content feed. In some embodiments, the user can navigate the content feed by performing a scroll gesture to move up or down the content feed.

In some embodiments, the content module 106 can obtain data corresponding to a content feed that is customized for a user. For example, the content module 106 and/or the social networking system can train (and retrain) machine learning models for ranking content items for potential presentation in content feeds that correspond to users of a social networking system. For example, the content module 106 and/or the social networking system can divide its users into different sets based on various attributes of the users (e.g., age, interests, language, etc.) and can generate one or more models for each set of users. Users with different attributes may have different behavioral patterns that can reflect their interests in different topics reflected by content items. As a result, different models for ranking content items for different sets of users can provide more accurate ranking of content items and provide a higher likelihood that users will be interested in the content items presented to them. In some embodiments, the features used to train the models can include interactions of users with content items of a content feed. Such interactions can include, for example, selecting a link in the content item, commenting on the content item, endorsing or “liking” the content item, selecting a reaction in response to the content item, sharing the content item with other entities (e.g., other users of the social networking system, social connections or “friends”, etc.), and hiding the content item. The content module 106 and/or the social networking system can use the models for each set of users to determine levels of interest of a user in content items. The level of interest of a user in each topic can be indicated by a topic score. A content item can be ranked for potential presentation to a user based on a topic(s) reflected by the content item and the topic score(s) of the user for the topic(s). Content items having a ranking that satisfies a selected threshold value can be presented to the user in her customized content feed.

In some embodiments, users may be able to access content feeds (e.g., channels) that correspond to specific topics. For example, the content items provided by the content module 106 and/or the social networking system may be categorized into one or more categories and/or be associated with one or more content feeds (e.g., channels) and these content feeds may include any number of content items that have been categorized and/or correspond to a particular category (e.g., sports, entertainment, music videos, etc.). Further, each content feed may be associated with a particular topic, theme, and/or entity (e.g., content publisher), to name some examples. Users can access and/or subscribe to one or more different content feeds to access the content items that are included in the respective content feeds. In some embodiments, content items (e.g., animated images, videos, audio files, etc.) in a content feed can begin playing as soon as a content item is positioned within a viewport region of the interface. The viewport region may be defined by a specified set of pixel coordinates that correspond to the display screen of the computing device through which the interface, or a portion of the interface, is accessed.

FIG. 2 illustrates an example of an interface module 202, according to an embodiment of the present disclosure. In some embodiments, the interface module 104 of FIG. 1 can be implemented with the interface module 202. As shown in the example of FIG. 2, the interface module 202 can include a content selection module 204, an in-app browser module 206, and a split interface module 208.

As mentioned, the interface module 202 can be configured to provide an interface (e.g., graphical user interface) through which content items (e.g., images, videos, audio files, etc.) can be presented and accessed. For example, the interface can be provided by a software application running on a computing device and through a display screen associated with the computing device. The content provided through the interface can be obtained by the content module 106 of FIG. 1, for example.

In some embodiments, a user can browse the different content items included in a content feed being provided by the social networking system. In one example, the user can browse the content feed by performing a scroll gesture to move the content feed up or down. Naturally, the interface can be configured differently to allow for other types of gestures to be utilized for navigating the content feeds. For example, in some implementations, the user can browse content items in a content feed by performing a swipe gesture to move to the left or right of the content feed. Other example gestures include long-press gestures, drag gestures, slide gestures, tap gestures, pinch gestures, spread gestures, rotate gestures, and flick gestures.

In some embodiments, a content feed can provide a portion, or snippet (e.g., including a title, summary, text excerpt, images, frames, etc.), of a content item, and this snippet can link to external content which may include the content item in its entirety. For example, the content feed can include a snippet of a news article (e.g., external content) that was published through a third-party content provider system. In some embodiments, the external content may be a web page that is hosted, or provided, by a content provider system that is external to the social networking system. The web page may be composed using a markup language (e.g., HTML), and also may include content (e.g., images, videos, audio, etc.) and executable code (e.g., JavaScript) to be interpreted when the web page is rendered. In various embodiments, a user accessing a content feed may access a content item or snippet that references such external content. In such embodiments, the content selection module 204 can detect that the user has accessed the content item or snippet. For example, the user may select the content item by performing a gesture (e.g., tap gesture) or selecting the content item using an input apparatus (e.g., keyboard, mouse, etc.). Once selected, the external content can be obtained and rendered for presentation through the interface.

In various embodiments, the in-app browser module 206 can be configured to render external content for presentation through the interface. For example, a content item being presented through the interface may include a link to a web page. In this example, when the link to the web page is selected, the in-app browser module 206 can be configured to obtain, or download, data describing the web page (e.g., HTML, content associated with the web page, and/or any executable code associated with the web page, etc.) from the computing system through which the external content is published or hosted. Further, the in-app browser module 206 can be configured to render the web page for presentation through the interface. In various embodiments, such rendering can involve, among other things, parsing any markup language (e.g., HTML) associated with the web page, executing code (e.g., JavaScript) associated with the web page, and/or formatting the layout and style of the web page, to name some examples.

In some embodiments, the split interface module 208 can be utilized to present certain content items that are associated with external content through a split interface. In such embodiments, the split interface can include a first region through which the content item being accessed is presented and a second region through which the external content is rendered and presented. For example, the content item being accessed may be a video that is associated with a website (e.g., http://www.example.com). In this example, when the user selects the video for playback, the interface provided by the interface module 202 can be modified by the split interface module 208 to be a split screen interface that includes a first region (e.g., top portion of the split screen interface) and a second region (e.g., bottom portion of the split screen interface). Here, the video can be played through the first region of the split screen interface while the website is rendered and presented through the second region of the split screen interface. Thus, in this example, the data for playing the video in the first region is obtained from the social networking system while the external data (e.g., website) presented in the second region is obtained from a third-party computing system through which the external content is published. The split screen interface can be configured differently depending on the implementation. In one example, the split screen interface is divided horizontally so that the first region appears on top of the second region. In another example, the split screen interface is divided vertically so that the first region appears alongside the second region. In another example, the split screen interface is divided diagonally so that the first region and the second region are separated by a diagonal line. Depending on the implementation, different sizes may be pre-defined for the first region and the second region. For example, the first region may be initially sized to use 40 percent of the display screen while the second region may be initially sized to use 60 percent of the display screen. Such pre-defined sizes can be adjusted, for example, by the user as described herein. In some embodiments, the first region also provides options for engaging with the content item. Such options can include an option to like the content item, an option to post a comment in response to the content item, options to react to the content item, and/or an option to share the content item with other users. In various embodiments, content items that are not associated with external content are presented in an interface that does not utilize a split screen.

In some embodiments, the split screen interface can include an option that causes the second region through which the external content is being presented to be closed or collapsed. As a result, the first region of the split interface expands to fill the display screen. In some embodiments, the split interface can include an option that causes the first region through which the content item is being presented to be closed or collapsed. As a result, the second region of the split interface expands to fill the display screen. In some embodiments, the split interface can include an option that allows the user to return to the content feed. In such embodiments, upon selecting the option, presentation of the split screen interface ceases and the display screen is updated to present the content feed that was previously being displayed. More details describing the split screen interface will be provided below.

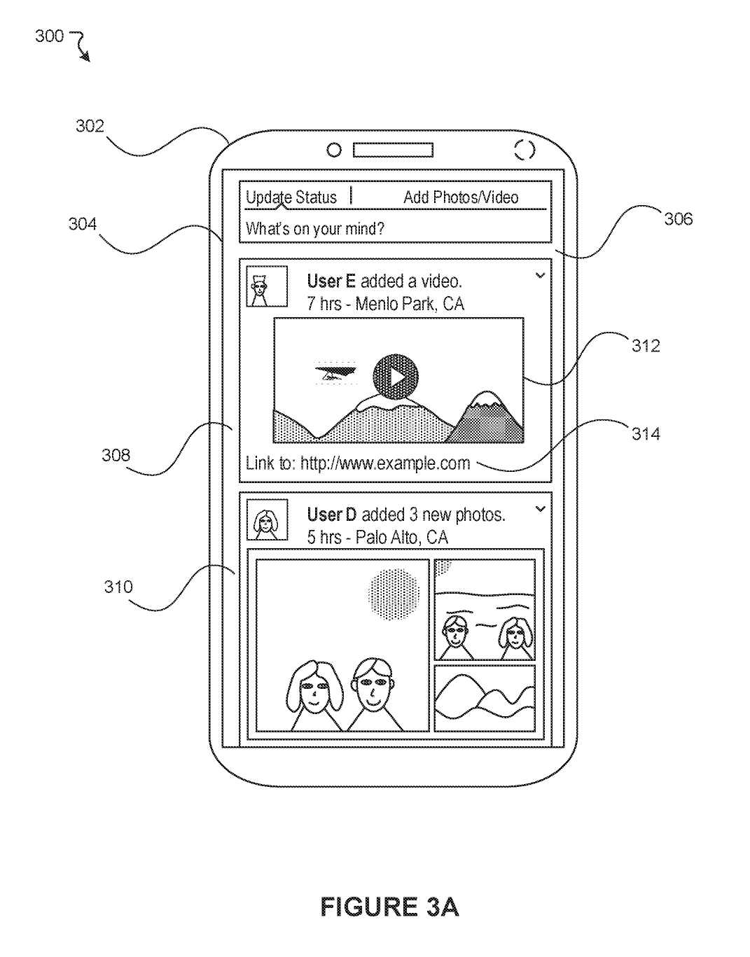

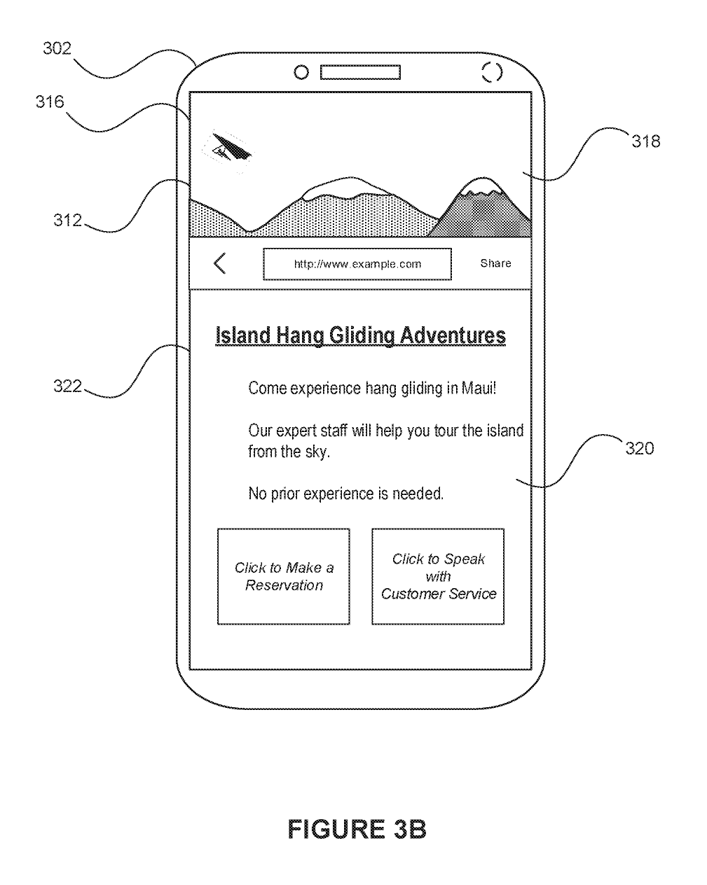

FIG. 3A illustrates an example 300 of an interface 304 through which content items 308, 310 are presented in a content feed 306, according to an embodiment of the present disclosure. In this example, the interface 304 is presented on a display screen of the computing device 302. Further, the interface 304 may be provided through an application (e.g., a web browser, a social networking application, etc.) running on the computing device 302. The user operating the computing device 302 can scroll through the content feed 306, for example, by performing a scroll gesture. In the example of FIG. 3A, the content item 308 includes a video 312 and a link 314 that references external content (e.g., a website). As mentioned, in some embodiments, when a user operating the computing device 302 selects the video 312 for playback, the interface 304 can be updated to a split screen interface 316, as illustrated in the example of FIG. 3B. In this example, the split screen interface 316 includes a first region 318 and a second region 320. In such embodiments, the video 312 can be played in the first region 318 of the split screen interface 316 while the external content, e.g., website 322, is rendered and presented in the second region 320 of the split screen interface 316.

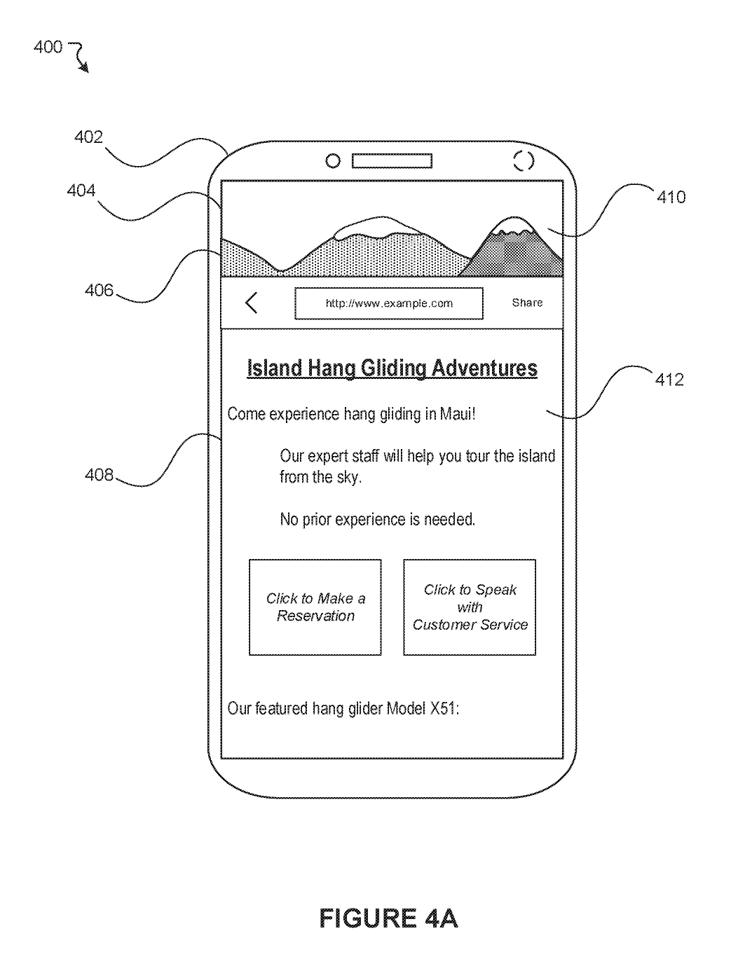

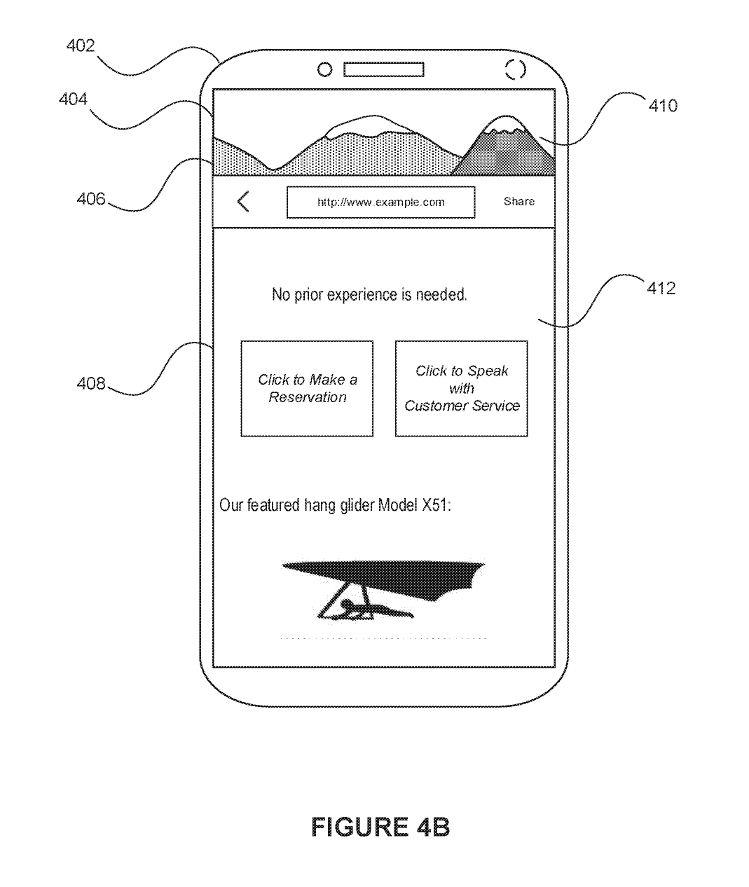

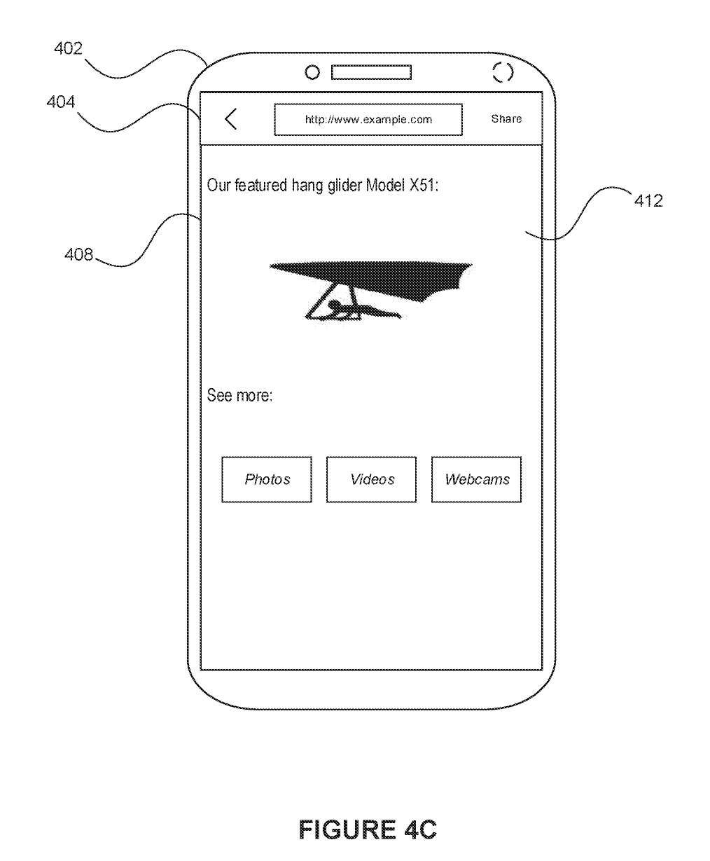

FIG. 4A illustrates an example 400 of an interface 404. The interface 404 is an another example of a split screen interface. The split screen interface 404 is presented on a display screen of the computing device 402. Further, the split screen interface 404 may be provided through an application (e.g., a web browser, a social networking application, etc.) running on the computing device 402. In this example, the user operating the computing device 402 has selected to access a content item that includes a video 406 and also references external content 408. Upon selecting the video 406 for playback, the video 406 is played in a first region 410 and the external content 408 is rendered and presented in a second region 412. While the video 406 plays, the user operating the computing device 402 can browse the website 408 as if the website 408 were rendered in a traditional browser application, as shown in the example of FIG. 4B. In some embodiments, the first region 410 is collapsible. That is, the user operating the computing device 402 can enlarge the second region 412 using one or more gestures (e.g., a drag or pull gesture). As the size of the second region 412 increases, the size of the first region 410 is reduced. As shown in the example of FIG. 4C, the user can drag the second region 412 so as to completely collapse the first region 410 (e.g., by dragging the second region 412 to the top of the display screen). As a result, the video playback in the first region 410 is no longer shown, thereby allowing the user to browse the external content 408 in full screen mode. Similarly, in some embodiments, the second region 412 is collapsible. That is, the user operating the computing device 402 can enlarge the first region 410 using one or more gestures (e.g., a drag or pull gesture). As the size of the first region 410 increases, the size of the second region 412 is reduced. For example, the user can drag the first region 410 so as to completely collapse the second region 412 (e.g., by dragging the first region 410 to the bottom of the display screen). As a result, the video playback in the first region 410 is shown in full screen.

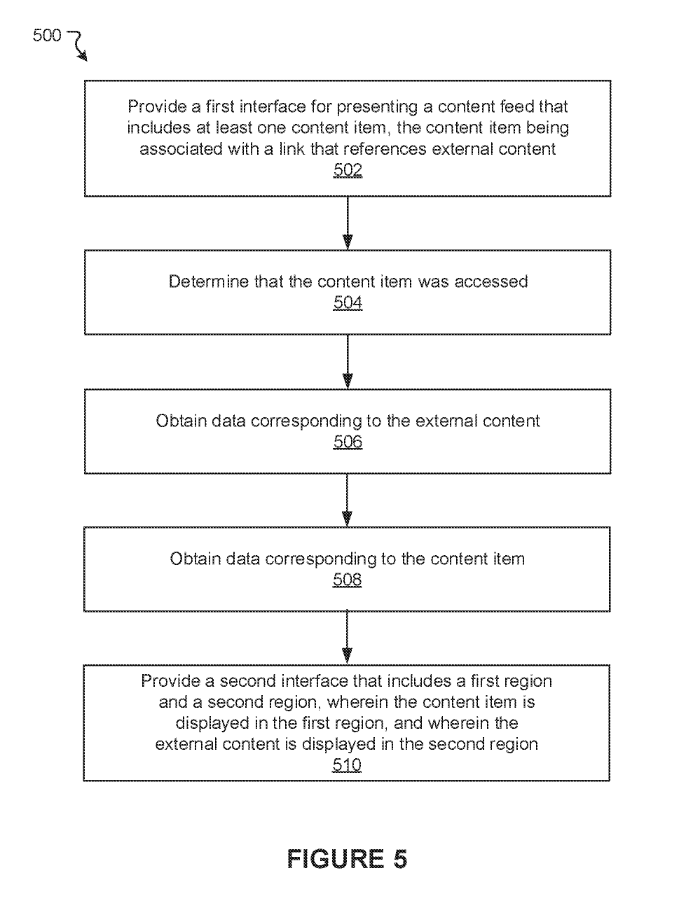

FIG. 5 illustrates an example method 500 for presenting content items with external content, according to an embodiment of the present disclosure. It should be appreciated that there can be additional, fewer, or alternative steps performed in similar or alternative orders, or in parallel, within the scope of the various embodiments discussed herein unless otherwise stated. At block 502, the example method 500 can provide a first interface for presenting a content feed that includes at least one content item, the content item being associated with a link that references external content. At block 504, a determination is made that the content item was accessed. At block 506, data corresponding to the external content is obtained. At block 508, data corresponding to the content item is obtained. At block 510, a second interface that includes a first region and a second region is provided, wherein the content item is displayed in the first region, and wherein the external content is displayed in the second region.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the user device 610 and/or the social networking system 630 can include a content presentation module 646. The content presentation module 646 can, for example, be implemented as the content presentation module 102 of FIG. 1. As discussed previously, it should be appreciated that there can be many variations or other possibilities.

### Hardware Implementation

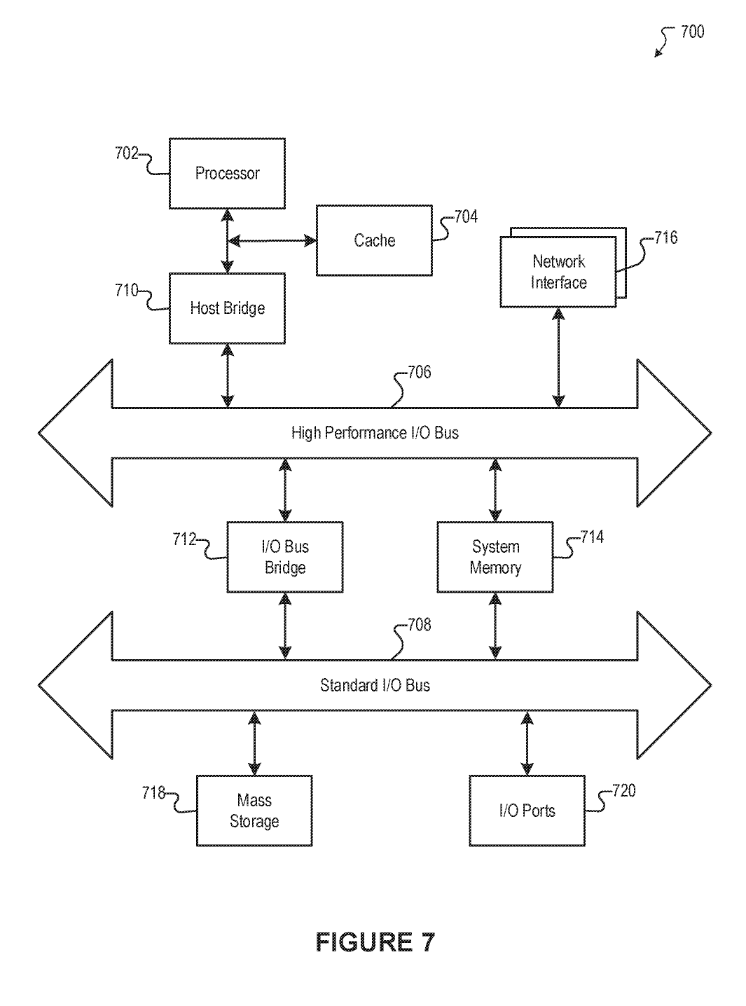

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
providing, by a computing device, a first interface for presenting a content feed that includes at least one content item, the content item being associated with a link that references external content;
determining, by the computing device, that the content item was accessed;
obtaining, by the computing device, data corresponding to the external content;
obtaining, by the computing device, data corresponding to the content item; and
providing, by the computing device, a second interface that includes a first region and a second region, wherein the content item is displayed in the first region, and wherein the external content is displayed in the second region.

2. The computer-implemented method of claim 1, wherein the data corresponding to the external content is obtained from a first computing system and the data corresponding to the content item is obtained from a second computing system.

3. The computer-implemented method of claim 2, wherein the first computing system is a third-party computing system, and wherein the second computing system is a social networking system.

4. The computer-implemented method of claim 1, wherein the second interface includes an option for collapsing the first region, and wherein, upon selecting the option, the second region in which the external content is being displayed expands to fill the second interface.

5. The computer-implemented method of claim 1, wherein the second interface includes an option for collapsing the second region, and wherein, upon selecting the option, the first region in which the content item is being displayed expands to fill the second interface.

6. The computer-implemented method of claim 1, the method further comprising:
detecting, by the computing device, a gesture for adjusting the second interface; and
adjusting, by the computing device, a size of the first region and a size of the second region in response to the gesture.

7. The computer-implemented method of claim 1, wherein the content item corresponds to a video, and wherein playback of the video is presented in the first region.

8. The computer-implemented method of claim 1, wherein the external content corresponds to web content, and wherein the web content is rendered and presented in the second region.

9. The computer-implemented method of claim 1, the method further comprising:
determining, by the computing device, that an option to close the second interface was selected; and
providing, by the computing device, the first interface for presenting the content feed, wherein the first interface replaces the second interface.

10. The computer-implemented method of claim 1, wherein the first region includes one or more options for engaging with the content item, the options including at least one of: a like option, a comment option, a share option, and one or more reaction options.

11. A system comprising:
at least one processor; and
a memory storing instructions that, when executed by the at least one processor, cause the system to perform:
providing a first interface for presenting a content feed that includes at least one content item, the content item being associated with a link that references external content;
determining that the content item was accessed;
obtaining data corresponding to the external content;
obtaining data corresponding to the content item; and
providing a second interface that includes a first region and a second region, wherein the content item is displayed in the first region, and wherein the external content is displayed in the second region.

12. The system of claim 11, wherein the data corresponding to the external content is obtained from a first computing system and the data corresponding to the content item is obtained from a second computing system.

13. The system of claim 12, wherein the first computing system is a third-party computing system, and wherein the second computing system is a social networking system.

14. The system of claim 11, wherein the second interface includes an option for collapsing the first region, and wherein, upon selecting the option, the second region in which the external content is being displayed expands to fill the second interface.

15. The system of claim 14, wherein the second interface includes an option for collapsing the second region, and wherein, upon selecting the option, the first region in which the content item is being displayed expands to fill the second interface.

16. A non-transitory computer-readable storage medium including instructions that, when executed by at least one processor of a computing system, cause the computing system to perform a method comprising:
providing a first interface for presenting a content feed that includes at least one content item, the content item being associated with a link that references external content;
determining that the content item was accessed;
obtaining data corresponding to the external content;
obtaining data corresponding to the content item; and
providing a second interface that includes a first region and a second region, wherein the content item is displayed in the first region, and wherein the external content is displayed in the second region.

17. The non-transitory computer-readable storage medium of claim 16, wherein the data corresponding to the external content is obtained from a first computing system and the data corresponding to the content item is obtained from a second computing system.

18. The non-transitory computer-readable storage medium of claim 17, wherein the first computing system is a third-party computing system, and wherein the second computing system is a social networking system.

19. The non-transitory computer-readable storage medium of claim 16, wherein the second interface includes an option for collapsing the first region, and wherein, upon selecting the option, the second region in which the external content is being displayed expands to fill the second interface.

20. The non-transitory computer-readable storage medium of claim 16, wherein the second interface includes an option for collapsing the second region, and wherein, upon selecting the option, the first region in which the content item is being displayed expands to fill the second interface.
